(19) United States
(12) Patent Application Publication
(10) Pub. No.: US 2007/0168997 A1
(43) Pub. Date: Jul. 19, 2007

(54) Debugging of remote application software on a local computer

(76) Inventor: Duong-Han Tran, Bad Schoenbom (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/313,975

(22) Filed: Dec. 20, 2005

(51) Int. Cl. G06F 9/44

(52) U.S. Cl. 717/129

(57) ABSTRACT

Methods and systems are provided for facilitating remote debugging from a local computer with a graphical user interface for debugging application in a computer system comprising an application system and one or more clients. The server receives a request from the local computer to monitor an application invoked by a client and running on the application system. Breakpoint information may be set via a breakpoint user interface initiated at the local computer by the server. Breakpoint information will be sent to one or more computer of the server system. The graphical user interface is provided to the local computer via a debugger interface initiated at the local computer by the server.

### DESCRIPTION OF THE INVENTION

1. Field of the Invention

The present invention relates to methods and systems for debugging software and, in particular, methods and systems for remote debugging of application software in an enterprise service network.

2. Background of the Invention

An enterprise services network is an open architecture incorporating services oriented architecture principles and web services technologies applied to enterprise business applications. Web services, and enterprise services networks, employ open standards, such as Extensible Markup Language (XML), Web Services Description Language (WSDL), HypterText Transfer Protocol (HTTP), Secure HypterText Transfer Protocol (S-HTTP or HTTPS), Simple Object Access Protocol (SOAP), Universal Description, Discovery and Integration (UDDI), Business Process Modeling Language (BPML), Business Process Execution Language (BPEL), and others, to allow for system integration independent of technical architecture and interoperability between even disparate platforms. Enterprise services allow IT organizations to develop applications, that is, applications that combine functionality and information from various, existing, application systems to support new business processes or scenarios. Web services that provide the functionality of one application system are also called “application services.”

Many enterprise services networks are heterogeneous, that is, they comprise several different customer and vendor platforms. For example, an enterprise services network may comprise SAP systems, such as SAP's NetWeaver™, SAP's development and integration platform running Advanced Business Application Programming (ABAP), SAP's application programming language, or an Internet Transaction Server (ITS), and non-SAP systems, such as a platform running Java 2 Platform Enterprise Edition™ (J2EE), such as IBM's WebSphere. An ITS is an interface that enables efficient communication between an SAP R/3 system of applications and the Internet, enabling user access to Internet application components, which are Web-enabled business applications for the R/3 system. J2EE is the standard platform, developed collaboratively by Sun Microsystems and other software vendors, for developing multi-tier enterprise applications based on the Java programming language.

On heterogeneous networks, it can be difficult to debug errors that occur during running of an application, particularly an application on a non-SAP system. One way to debug an application is to use a debugger interface that allows a user to debug application coding to determine whether there are any design or implementation errors. However, already existing debugger interfaces in a heterogeneous environment have limitations. For example, a developer working on an SAP platform can enable an ABAP debugger via Remote Function Call (RFC) where the ABAP debugger is only available on the same computer as the RFC client, but the ABAP debugger is not available for the HTTP client. In another example, when using the so-called “External Debugging” tool, a developer can set “breakpoints” to debug an application communicating with a HTTP client; however, the developer has to set these breakpoints from within the specific application server to which the HTTP client is connected. This is necessary since the external debugging does not work properly if the HTTP client uses the load balancing feature to connect the user to the application server having the lightest load. In another example, a developer working on an SAP platform cannot set breakpoints outside of the application system.

What is needed are methods and systems that provide developers and customers the ability to enable a remote debugger without changing the application coding or the external applications, define the computer where the remote debugger initiates, set breakpoints within the particular software to avoid debugging through any external system, set breakpoints on a specific servers or on all application servers of a logon group, provide security mechanisms to prevent unauthorized debugging, and activate a remote debugger from within the application system and from a developer environment.

### SUMMARY OF THE INVENTION

In accordance with the invention, methods for facilitating remote debugging of an application on a local computer comprises receiving identification information from the first client, the identification information comprising a first client identifier; receiving a request from the first client to monitor an application invoked by a second client and running on the application system; receiving breakpoint information via a breakpoint user interface initiated at the first client by the server; setting breakpoints in the application based on the breakpoint information; and providing the breakpoint information to the first client via a debugger interface initiated at the first client by the server. A system for facilitating remote debugging of an application comprises a processor; and a memory, wherein the processor and the memory are configured to perform the claimed methods.

It is to be understood that both the foregoing general description and the following detailed description are exemplary and explanatory only and are not restrictive of the invention, as claimed. These and other embodiments are further discussed below with respect to the following figures.

### BRIEF DESCRIPTION OF THE DRAWINGS

FIG. 1 is a block diagram of an exemplary system for providing remote debugging.

FIG. 2 is a functional diagram showing message flow in the exemplary system in FIG. 1 for providing remote debugging via a developer environment.

FIG. 3 illustrates an exemplary breakpoint interface consistent with the present invention.

FIG. 4 illustrates an exemplary invocation of a debugger interface consistent with the present invention.

FIG. 5 is a flow chart representing an exemplary method for remote debugging via a developer environment.

FIG. 6 is a functional diagram showing message flow in the exemplary system in FIG. 1 for providing remote debugging via an user interface.

FIG. 7 illustrates an exemplary breakpoint interface consistent with the present invention.

FIG. 8 illustrates a flow chart representing an exemplary method for remote debugging via an user interface.

### DESCRIPTION OF THE EMBODIMENTS

Reference will now be made in detail to the exemplary embodiments of the invention, the examples of which are illustrated in the accompanying drawings. Wherever possible, the same reference numbers will be used throughout the drawings to refer to the same or like parts.

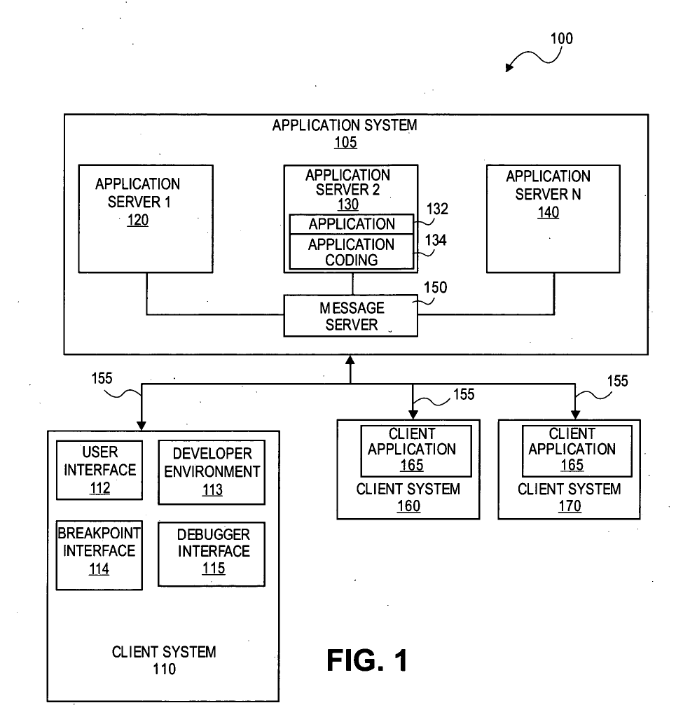

FIG. 1 is a block diagram of an exemplary system 100 for providing remote debugging of an application system consistent with the present invention. As shown in FIG. 1, system 100 includes an application system 105 and at least two client systems 110 and 160. System 100 may also include additional client systems, such as client system 170.

As shown in FIG. 1, application system 105 may include one or more application servers 120, 130, 140. In some exemplary embodiments, application system 105 may be a platform running SAP's NetWeaver, SAP's suite of development and integration components. One of the components of SAP's NetWeaver is SAP Web Application Server (SAP Web AS), which supports both ABAP and Java code that meets the J2EE specifications.

Application system 105, and each of application servers 120, 130, 140, may communicate with client systems 110, 160, and 170 via a message server 150. Message server 150 is, for example, an independent program, process, or application server whose role is to inform servers belonging to a system of the existence of other servers in the system. It can also be contacted by external client systems (for example, SAP Logon, RFC clients with load balancing) to get information about load balancing within the application system. Message server 150 determines which server within a group of servers a user logs on to and also handles communication between the application servers within the group. An SAP system consisting of any number of application servers contains only one message server.

In certain other embodiments, application system 105, and each of application servers 120, 130, 140 may communicate with client systems 110, 160, and 170 via one or more gateways, such as a router, a firewall server, a host, or a proxy server (not shown). One or more of application servers 120, 130, 140 may share a common gateway or have a dedicated gateway. In such embodiments, communications between application server 130 and client systems 110, 160, or 170 may be via a shared or dedicated gateway.

In FIG. 1, external applications register at message server 150 to enable communication with one or more application servers. Application servers 120, 130, 140 communicate with client systems 110, 160, and/or 170 using conventional network connections 155. Conventional network connections 155 may include, alone or in any suitable combination, a telephony-based network, a local area network (LAN), a wide area network (WAN), a dedicated intranet, wireless LAN, the Internet, a wireless network, a bus, or any other any communication mechanisms. Further, any suitable combination of wired and/or wireless components and systems may be used to provide network connections 155. Moreover, network connections 155 may be embodied using bi-directional or unidirectional communication links. Further, network connections 155 may implement protocols, such as RFC, Transmission Control Protocol/Internet Protocol (TCP/IP), HTTP, SOAP, and the like.

As shown in FIG. 1, application server 130 includes at least one application 132 and at least one application coding 134. Although shown only with respect to application server 130, each of application servers 120, 140 may likewise comprise an application 132 and application coding 134. Application 132 may be any enterprise application such as, for example, SAP's Customer Relationship Management (CRM) or Supply Chain Management (SCM) products. Application 132 may also be a composite application, such as any of the components of SAP's xApps family, or may be a custom application. Application 132 may be activated by, for example, the client application 165 running on client system 160 or 170.

Application coding 134 can invoke a user interface on any other computer in an enterprise service network, send data to the user interface to display and receive input data from the user interface. Application coding 134 translates returning messages and data into the appropriate format for transmission back to the client application 165 on client systems 160 or 170. For example, application coding 134 may translate messages generated by application 132 into message formats used by the network protocols mentioned above, that is, TCP/IP, HTTP, SOAP, RFC, and the like. Application coding 134 may also translate data generated by application 132 into standard data formats such as XML, WSDL, and the like.

Client system 110 may be, for example, a conventional personal computer (PC) or other computing device including, for example, a processor, a random access memory (RAM), a program memory (for example, read-only memory (ROM), a flash ROM), a hard drive controller, a video controller, and an input/output (I/O) controller coupled by a processor (CPU) bus. Client system 110 is remote from the application system 105. In certain embodiments, a display (not shown) and one or more user input devices (not shown) can be coupled to client system 110 via an I/O bus. Alternatively, separate connections (separate buses) can be used for the display and the user input devices. While one client system 110 is shown in FIG. 1, any number of client systems may be connected to application system 105. Client system 110 allows a user to display, access, and manipulate data located at the application system 105. Client system 110 receives user commands and data as input and displays result data as output.

Client system 110 may have one or more modules or tools, such a user interface 112, developer environment 113, breakpoint interface 114, and debugger interface 115.

The user interface 112 can be, for example, a web-based interface having a web browser or can be a non-web interface, such as a SAP GUI. User interface 112 supports client-side processing and allows a user to access and complete software transactions in an application system 105. The user interface can include, for example, text fields of elements for input/output of data, display menus, and elements for making selections, making adjustments, and grouping objects. In some embodiments, the user interface 112 can invoke additional user interfaces to monitor ABAP code. In some embodiments, user interface allows a user to choose which client system displays these additional user interfaces, for example, such as breakpoint interface. In addition, for example, the user interface 112 can contain transactions SRDEBUG and the function group REMOTE_DEBUGGING.

Developer environment 113 allows a user to develop multi-layered applications, such as Java-based applications. The developer environment 113 can be, for example, SAP NetWeaver Developer Studio, where the applications would be Web Dynpro or J2EE applications. In some embodiments, the developer environment 113 can invoke additional user interfaces. In some embodiments, developer environment includes program Abapdebugger based on SAP Java Connector (SAP JCO) and will be added as a plugin to the developer environment 113. In still other embodiments, developer environment 113 may be located on a platform or server operatively connected to client system 110 and application server 105.

Breakpoint interface 114 can be, for example, a SAPGUI for Set Breakpoints. Breakpoint interface 114 allows a user to set breakpoints within the application coding 134 of the application server 130. Breakpoints allow a user to instruct the application server to interrupt the application coding 134 at a particular point. Breakpoint interface 114 can further include a toggle button that can start or stop debugging of an application.

Debugger interface 115 allows a user to access developer tools, such as callstack, contents of variable, and others, to analyze the execution of the applications and determine whether the application coding 134 executed correctly. This can be done during the development of the software application coding or later in an execution environment. Debugger interface 115 can be, for example, SAPGUI for ABAP-Debugger.

Client systems 160 and 170 may be, for example, an ABAP server, a J2EE server, an Internet Transaction Server (ITS), or an SAP-Business Connector (SAP-BC) system. Client systems 160 and 170 include at least a processor, a random access memory (RAM), and a program memory (for example, read-only memory (ROM), a flash ROM), and can be operatively connected to a display, and at least one input device. In some embodiments consistent with the present invention, client systems 160 and 170 include at least one client application 165. The execution of the client application 165 can be monitored by the user interface 111 through the application coding 134. Client system may also comprise a web browser (not shown).

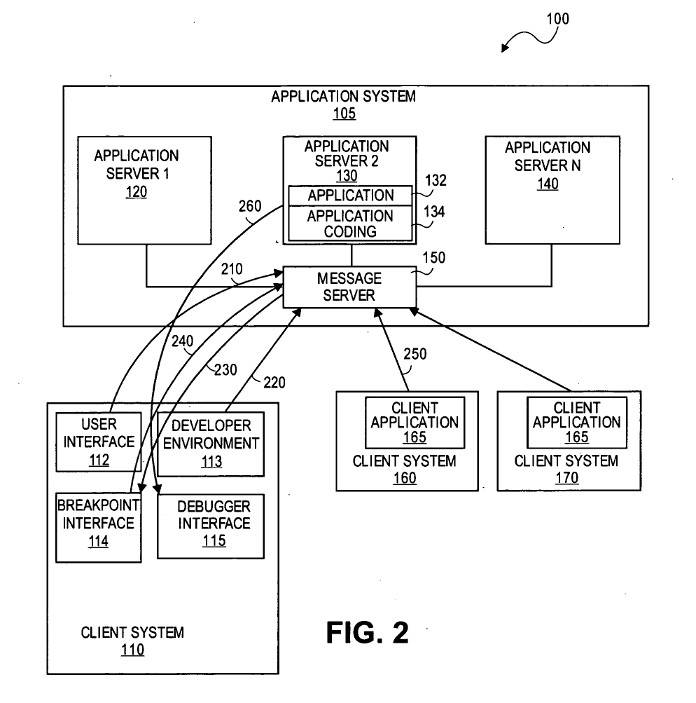

FIG. 2 is a functional diagram showing message flow in the exemplary system in FIG. 1 for providing remote debugging via developer environment. In this exemplary embodiment, it is assumed that an external connection exists between client systems 160 and/or 170 and application server 130.

First, to allow a user to debug application coding 134, which includes the interactions of the application 132 and/or client application 165, application server 130 establishes communication between the application server 130 and the client system 110 via user interface 112. User interface 112 provides (210) identification information to connect to application system 105. The identification information may include data such as client identifier, user ID, password, and, optionally, logon group.

In exemplary embodiments consistent with the present invention, the user may logon using SAP Logon, a Windows program that mediates between an SAP system and an SAP GUI interface. SAP Logon displays a list of available SAP systems and uses load balancing to automatically select servers with the best current response times or fewest users. Logon load balancing increases efficiency with respect to performance and the use of system resources for variously defined workgroups by distributing users across available application servers based on requirements for workgroup service and utilization.

For example, in an application system with multiple application servers, specific servers may be assigned to a particular application workgroup and the available resources and buffers of that server may be tuned specifically to that application and not shared with other applications. To log on to an SAP system, the user needs to know only the name of the SAP system and the logon group, but not the host name and system numbers. After the user has logged into application system 105 using the information it supplied, user interface 112 is initiated at the client system 110. The user then initiates a developer environment 113 on the client system 110 and allows the developer environment 113 to connect (220) to application server 130. For example, a user could invoke program AbapDebugger from within the SAP NetWeaver Developer Studio. The AbapDebugger would then execute the RFC function module SRDEBUG_START. In some embodiments, the developer environment 113 communicates with the application server 130 using a RFC protocol. In some embodiments, where developer environment 113 has established communication with application server 130, developer environment can connect to the other application servers 120, 140.

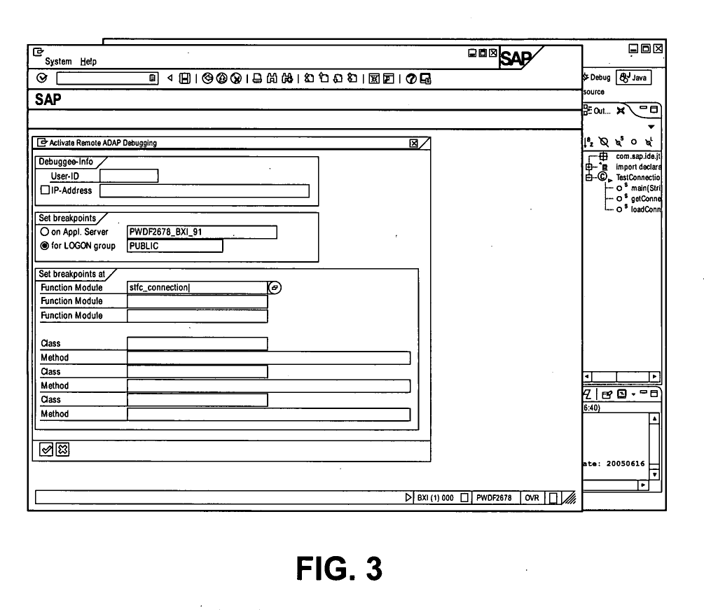

After developer environment 113 has connected to application server 130, it activates breakpoint interface 114 on client system 110. For example, the function module SRDEBUG_START displays the breakpoint interface 114 on the computer where the AbapDebugger was waiting. To set breakpoints within application 105, breakpoint interface 114 requires additional breakpoint-related information such as, among other things, user ID, IP-Address of the external device, names of function modules, classes, or methods, or whether to debug on a specific application server or all application servers of a logon group. In certain embodiments, some or all of the breakpoint-related information may be entered by the user who wishes to debug the application, such as an application developer. In some embodiments, some or all of the breakpoint-related information may be determined automatically. An exemplary breakpoint interface is illustrated in FIG. 3.

As shown in FIG. 3, a user may choose to “Set Breakpoint” on only the application server by indicating “on Appln. Server.” In this case, breakpoint-related information will only be sent to the specific application server identified. When the user indicates to set breakpoint “for LOGON group,” and specifies a LOGON group, the breakpoint information will be sent to all application servers of the indicated logon group.

Once the user provides the necessary breakpoint information, the breakpoint interface 114 provides (240) the breakpoint-related information to the application server or servers. Breakpoints are valid for all connections (already existent or new ones) using the same userlD from the same computer with the defined IP-Address. If a user does not activate the checkbox for the IP-Address (as shown in FIG. 3), all connections using the defined userlD will be debugged. In some embodiments, the breakpoint interface can be initiated by and communicate with the application server 130. This breakpoint-related information, except any passwords, can be set in the file AbapDebugger.properties for the following debugging sessions.

Once the breakpoint interface 114 has supplied breakpoint-related information to the application system 105, the client application 165 at the client system 160 initiates communication by, for example, requesting services from the application 132 (250). Although application 132 was already running, client application 165 receives transmissions from the application coding 134 with the next request to the application server 130.

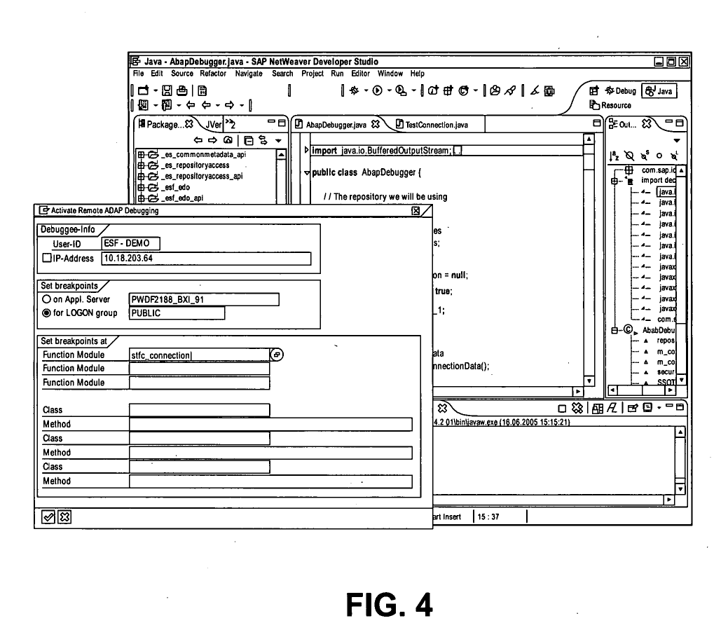

Since the breakpoint user interface 114 has supplied breakpoint information to the application system 105, application server 130 initiates (260) the debugger interface 215 at the client system. For example, if the debugging conditions were satisfied (for example, if the checkbox for IP-Address is not checked as shown in FIG. 3), the debugger interface will immediately be invoked on the client system 110 whether or not a connection exists between the client system 160 and the application system 105. An exemplary embodiment of the debugger interface is illustrated in FIG. 4. The debugger interface allows the user to monitor and analyze the debugging the application coding 134, which includes interaction data of application 132 and/or client application 165 on the client system 160. In addition, the debugger interface is independent of the communication protocol 155 between application coding 134 and the client application 165. For example, if the ABAP coding is running within an RFC function module or a class initiated by any kind of HTTP/HTTPS, a user can always debug the ABAP source.

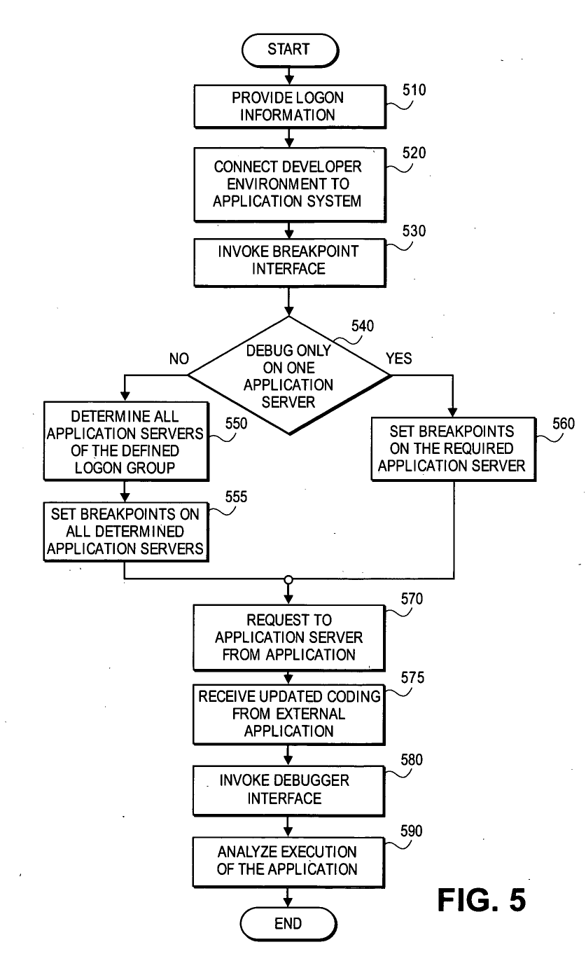

FIG. 5 is a flow chart representing an exemplary method for remote debugging via a developer environment. The method of FIG. 5 will be described with reference to the exemplary system shown in FIG. 1. To begin, user interface 112 provides identification information to connect to the application system 105 (step 510). The identification information may include data such as client, user ID, password, and logon group. The identification information may be used to, among other things, provide security to the application system so unauthorized users cannot modify the applications. For example, an application developer on client system 110 must login onto the application system 105 under a specific user-ID (such as, for example, DEV_USER) to set and provide some breakpoint-related information to one or all application servers of a logon group. After client application 165 connects to an application server using a specific user ID (such as, for example, EXT_USER) and if the breakpoint-conditions are satisfied on this application server, the application system 105 will first check whether the user DEV_USER has the authority to debug the connection running under the user EXT_USER.

The identification information may also be used to determine the types of permissions that authorized users may have when accessing the application system. For example, this requested information may include a firewall password so that a user, at the client system, could bypass a firewall and debug a remote customer's application system. When debugging on a customer ABAP application system via SAPRouter using the firewall password, an ABAP developer can login to the application system using SAPGUI and via Customer Service System as usual. Then the developer only has to run the transaction SRDEBUG and fill-in the required information.

After the user interface provides the identification information, the user initiates a developer environment on the client system and the developer environment connects to the application system (step 520). For example, a user could invoke program AbapDebugger from within the SAP NetWeaver Developer Studio.

After the developer environment connects to application system, the application system invokes the breakpoint interface (step 530). The breakpoint interface allows a user to enter various parameters that will be used by the application server to collect debug information. For example, the breakpoint interface may allow the user to specify such information as a user ID, IP Address of an external device running the application to be debugged, or names of certain function modules, classes, or methods within the application to be debugged, or whether to debug the application only on a specific application server or using a logon group.

The user may also specify whether to debug the application coding and/or the external application on only one application server or on a group of servers associated with a logon group (step 540). As shown in FIG. 3, for example, the user may choose by indicating either “on Appin. Server” or “for LOGON group” in the “Set Breakpoints area of the user interface. If the user chooses “on Appln. Server,” the breakpoint interface sets one or more breakpoints on the required application server and then returns control to the debugger tool (step 560).

If client application 165 uses load balancing to logon to application system 105 via a logon group of application servers, the user may wish to debug all applications servers in a specific LOGON group. In this case, the user may so indicate by, for example, choosing “for LOGON group” in the “Set Breakpoints” are of the exemplary user interface shown in FIG. 3. In certain embodiments, the user may also specify a LOGON group. The application servers of the logon group are determined by, for example, debugger interface 115 (step 550). Debugger interface 115 may determine such information by, for example, obtaining such information from message server 150. If the user selects a logon group, the breakpoint-related information will be passed to all application servers of this logon group and required breakpoints will be set in these application servers (step 555). For example, the function module SRDEBUG_START returns to the AbapDebugger information about the breakpoints and on which application servers these breakpoints should be set. As a result, for example, AbapDebugger starts different threads to connect to these application servers and sets the required breakpoints by calling the function module SRDEBUG_CONTINUE.

Preferably, the breakpoints should be set before client application 165 at the external system (client system 160) requests services from the application server (step 570), so that debugging is available from the beginning of communications. However, it is also possible to set breakpoints after the application is running on the application server. In this case, the breakpoints will become active for all following a request for services. (step 575).

Once the breakpoints are set and client application 165 at the client system 160 requests services from application 132 on application server 130 of application system 105 and the breakpoint conditions are filled, application server 130 invokes a debugger interface at the client system 110, such as debugger interface 115 (step 580). Debugger interface 115 receives information related to the source of the currently running function module, class, and methods containing the breakpoints. Information about the breakpoints at these sources is already known to each involved application server as described above.

After debugger interface 115 has been invoked, the user can then analyze (590) the coding of application 132, which includes data sent by the executed client application 165 of the client system 160. After the user debugs the data, the procedure can terminate by, for example, using breakpoint interface 114. For example, the Java program AbapDebugger may call the function module SRDEBUG_STOP to stop all debugging activities.

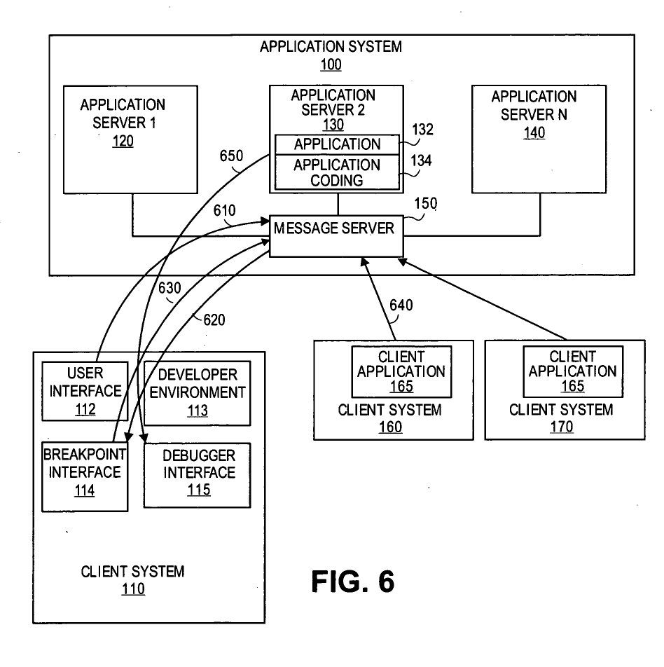

FIG. 6 is a functional diagram showing message flow in the exemplary system in FIG. 1 for providing remote debugging via client device 110. In this exemplary embodiment, it is assumed that an external connection exists between client system 160 and application server 130.

To allow a user to debug the application coding 134 on application server 130, a user logs on to a Customer Service System and user interface 112 establishes (610) a communication session with application server 130. For example, user interface 112 can run the transaction SRDEBUG. User interface 112 can establish communication with the application server 130 via, for example, message server 150.

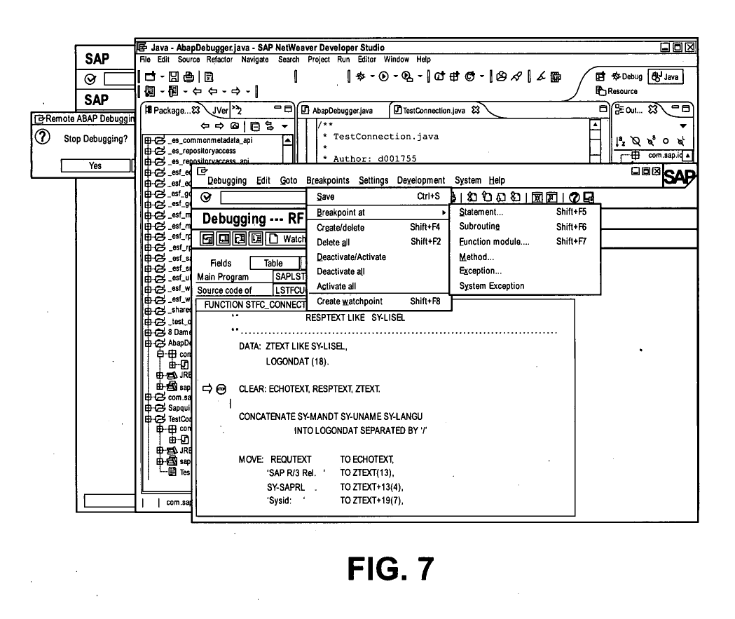

After user interface 113 runs a transaction (for example, SRDEBUG) and communicates with application server 130, application server 130 attaches (620) breakpoint interface 114 on client system 110. Breakpoint interface 114 requires additional breakpoint information such as, among other things, user ID, IP-Address of the external device, names of function modules, classes, and/or methods, or whether to debug on a specific application server or all application servers of a logon group. An exemplary breakpoint interface is illustrated in FIG. 7.

Once the user provides the necessary breakpoint information, the breakpoint interface 114 provides (630) the information to the application server 130. In some embodiments, the breakpoint interface can be initiated by and communicate with the application server 130.

Once the breakpoint interface 114 has been supplied to the application system 105 with the breakpoint information, the client application 165 at the client system 160 initiates communication by, for example, requesting services from application 132 (640). Although application 132 was already running when client application 165 at client system 160 receives transmissions from the application coding 134 with the next request to the application server 130.

Since the breakpoint user interface 114 has supplied breakpoint information to the application system 105 and when all debugging conditions are satisfied, application server 130 initiates (650) debugger interface 215 at the client system 110. In some embodiments, once the breakpoint-debugging conditions are met, the debugger interface 115 can automatically be displayed on client system 110 whether or not an external connection already exists. The debugger interface allows the user to monitor and analyze the debugging information regarding the application coding 134, which can include the interactions of application 132 and/or client application 165. In addition, debugger interface 115 is independent of the communication protocol 155 between application coding 134 and the secondary applications 165. For example, if the ABAP coding is running within an RFC function module or a class initiated by any kind of HTTP/HTTPS, a user can always debug the ABAP source.

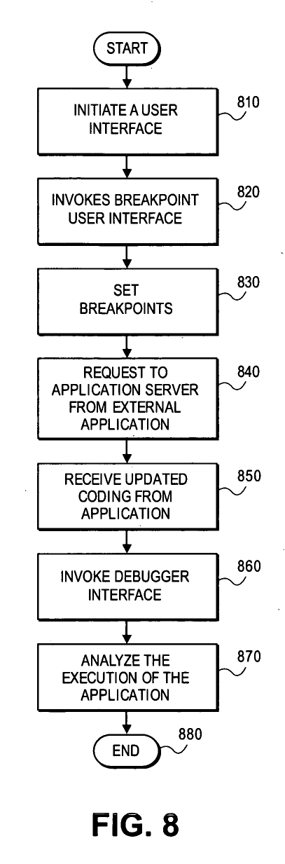

FIG. 8 illustrates a flow chart representing an exemplary method for remote debugging via a debugger interface. The method of FIG. 8 will be described with reference to the exemplary system shown in FIG. 1. To begin, user interface 112 is initiated (810) at the client system. The user interface can monitor the application coding, which can include information regarding the interactions between internal application and external applications.

After user interface is initiated, the application system invokes (820) the breakpoint interface. When the breakpoint interface is initialized, the breakpoint interface allows a user to instruct the application server to interrupt the application coding at a particular point. Breakpoint interface 114 requires additional breakpoint information such as, among other things, user ID, IP-Address of the external device, names function modules, classes, or methods, or whether to debug on a specific application server or all application servers of a logon group. In some embodiments, the breakpoint interface provides up to three function modules and/or up to three classes and methods to debug. For example, in one exemplary embodiment, when information is transmitted to a logon group, the server that has the lightest load receives the breakpoint information.

After initiating the breakpoint interface, the user sets a breakpoint to debug (830) the application coding on either the current application server, the logon group of application servers, or a different application server by providing one or more function modules, and one or more classes and methods to debug. For example, the user can set the breakpoints for the LOGON-group by using an asynchronous RFC (aRFC) protocol.

After setting the breakpoints, the external application at the external system requests (840) services from the application coding . Although application at applications server was already running, external application receives (850) transmission from the application coding with the next request to the application server 130.

Once the breakpoints are set and the external application receives transmission from application coding, the application system 105 invokes (860) the debugger interface at the client system. Debugger interface receives correspondences relating to the debugging of the function module, class, and methods assigned within applications at the application server and the external system. Since the debugger interface has been invoked, the user can then analyze (870) application coding, which can include the interactions of applications and/or external applications of the external system. After the user debugs the data, the procedure can terminate.

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for facilitating remote debugging of an application in a computer system comprising an application system, a first client, and a second client, the method comprising:
receiving identification information from the first client, the identification information comprising a first client identifier;
receiving a request from the first client to monitor an application invoked by a second client and running on the application system;
receiving breakpoint information via a breakpoint user interface initiated at the first client by the server;
setting breakpoints in the application based on the breakpoint information; and
providing the breakpoint information to the first client via a debugger interface initiated at the first client by the server.

2. The method of claim 1, wherein the identification information comprises a user identifier and password; and the method further comprises
authenticating a user at the first client based on the user identifier and password.

3. The method of claim 1, wherein the breakpoint information comprises a user ID of a user running the application, and setting breakpoints in the application further comprises setting breakpoints based on the user ID.

4. The method of claim 1, wherein the breakpoint information comprises a logon group; and setting breakpoints in the application further comprises setting breakpoints in the application on all application servers in the logon group.

5. The method of claim 1, wherein the breakpoint information comprises an IP address of the second client and setting breakpoints in the application further comprises setting breakpoints in the application on the second client.

6. A system for facilitating remote debugging of an application in a computer system comprising an application system, a first client, and a second client, the system comprising:
a processor; and
a memory, wherein the processor and the memory are configured to perform a method comprising:
receiving identification information from the first client, the identification information comprising a first client identifier;
receiving a request from the first client to monitor an application invoked by a second client and running on the application system;
receiving breakpoint information via a breakpoint user interface initiated at the first client by the server;
setting breakpoints in the application based on the breakpoint information; and
providing the breakpoint information to the first client via a debugger interface initiated at the first client by the server.

7. The system of claim 6, wherein the identification information comprises a user identifier and password; and the method further comprises
authenticating a user at the first client based on the user identifier and password.

8. The system of claim 6, wherein the breakpoint information comprises a user ID of a user running the application, and setting breakpoints in the application further comprises setting breakpoints based on the user ID.

9. The system of claim 6, wherein the breakpoint information comprises a logon group; and setting breakpoints in the application further comprises setting breakpoints in the application on all application servers in the logon group.

10. The system of claim 6, wherein the breakpoint information comprises an IP address of the second client and setting breakpoints in the application further comprises setting breakpoints in the application on the second client.

11. A system for calling a service provider using a service manager and a local client proxy, the system comprising:
means for receiving identification information from the first client, the identification information comprising a first client identifier;
means for receiving a request from the first client to monitor an application invoked by a second client and running on the application system;
means for receiving breakpoint information via a breakpoint user interface initiated at the first client by the server;
means for setting breakpoints in the application based on the breakpoint information; and
means for providing the breakpoint information to the first client via a debugger interface initiated at the first client by the server.
